(19) United States
(12) Patent Application Publication
(10) Pub. No.: US 2012/0257141 A1
(43) Pub. Date: Oct. 11, 2012

(54) LIQUID CRYSTAL DISPLAY DEVICE WITH TRANSMISSIVE AND REFLECTIVE UNITS

(75) Inventors: Cheng-Chung PENG, Chu-Nan (TW); Hsin-Ta LEE, Chu-Nan (TW)

(73) Assignee: CHIMEI INNOLUX CORPORATION, Chu-Nan (TW)

(21) Appl. No.: 13/441,372

(22) Filed: Apr. 6, 2012

(30) Foreign Application Priority Data
Apr. 8, 2011 (TW) 100112241

(51) Int. Cl. G02F 1/13357; G02F 1/1335

(52) U.S. Cl. 349/62; 349/96

(57) ABSTRACT

A liquid crystal display device with transmissive and reflective units is provided. At least a bare unit is formed in a predetermined portion of the first electrode. A reflective layer is disposed on the second electrode at a location corresponding to the bare unit. A liquid crystal display unit is defined in an extension direction between the second and first electrodes. The liquid crystal display unit has a portion corresponding to the bare unit and defined as a reflective unit and another portion that surrounds outside the reflective unit and defined as a transmissive unit. The liquid crystal layers show an effective electrical field that is weaker within the reflective unit than within the transmissive unit. The transmissive unit has a circumferential edge portion spaced away from the reflective unit and forming an additional reflective unit for the liquid crystal display unit.

### CROSS REFERENCE TO RELATED APPLICATIONS

This application claims priority of Taiwan Patent Application Number 100112241 filed Apr. 8, 2011, which is herein incorporated by reference.

### BACKGROUND OF THE INVENTION

1. Field of Invention

The present invention relates to a liquid crystal display device and manufacturing method thereof more particularly, the present invention relates to a technique which is effective to a liquid crystal display device with transmissive and reflective units.

2. Related Art

Liquid crystal display devices are currently indispensable output devices in various fields. A typical liquid crystal display device generally includes a pair of substrates, a pair of electrodes, and a liquid crystal layer between the electrodes. The liquid crystal layer contains therein liquid crystal molecules.

In order to keep the best quality of the liquid crystal display device under the bright environment, various types of transflective structure have been developed. For example, different thicknesses of the liquid crystal layers were used in the space of the liquid crystal layer of the transmissive and the reflective units. However, such a known structure has disadvantageous of complicated manufacturing process and low yield problem.

In the prior art structure which is disclosed in Taiwan Patent Publication No. 200846773, identical thicknesses is applied to the liquid crystal layer of a transmissive unit and a reflective units, but a multiple-electrode structure is used. This known structure is disadvantageous in including a complicated driving circuit design.

In the structure disclosed in Taiwan Patent Publication Number 200835971, identical thickness is applied to the liquid crystal layer of a transmissive unit and a reflective unit. However, an additional reflective wire-grid type polarizer must be used in the reflective unit. In such a known structure, due to the use of an additional reflective wire-grid type polarizer in the reflective unit, the manufacturing process is complicated.

In the structure disclosed in Taiwan Patent Publication Number 200907516, identical thicknesses is applied to the liquid crystal layer of the transmissive and the reflective units, but different electric field distribution is formed by utilizing different characteristics of the transparent electrode pattern of the transmissive and the reflective units in order to achieve that the electric field of the reflective unit is weaker than the electric field of the transmissive unit. Then, the periodic arrangement of the electrode pattern is adjusted to achieve better similarity between the voltage-transmittance curve and the voltage-reflective curve. This known structure suffers poor matching between the voltage dependent transmittance and reflectance curves.

### SUMMARY OF THE INVENTION

The known technologies mentioned above each show advantages, but still suffer certain shortcomings. Thus, the present invention aims to provide a liquid crystal display device that possess both a transmissive unit and a reflective unit, wherein the transmissive and the reflective units are of the same thickness of the liquid crystal layer, but the reflective unit is set in a portion of a pixel where the liquid crystal molecules are subject to an effective electrical field that is weaker. The size and location of the reflective unit is determined through trade-off between two indexes in respect of light utilization efficiency and similarity between a Voltage-Transmittance curve and a Voltage-Reflective curve so as to realize an optimum display effect.

The technical solution adopted in the present invention to solve such problems of the known art is form a bare unit of a specific pattern or shape in an upper ITO electrode of a liquid crystal display device. The specific shape or pattern can be for example a circle, an ellipse, a rectangle, or the other symmetry shapes. Liquid crystal molecules located within the bare unit are subject to a weak effective electrical field relatively, phase retardation of the liquid crystal layer is smaller, and the transmittance of the bare unit is relatively weaker so as to cause a decline in transmittance of the whole pixel and in the light utilization. However, according to the present invention, such an area is changed to serve as a reflective unit such that the accumulated phase retardation of light propagating through the liquid crystal layer is increased to twice of that of the original transmissive unit. Thus, the light utilization of the whole display device is enhanced and a liquid crystal display device with transmissive and reflective units is provided to improve the image quality of the display device in a bright environment.

According to the present invention, a transmissive unit in a liquid crystal layer that shows a weak effective electric field and provides a small phase retardation for light propagating through the liquid crystal layer that causes low transmittance is changed to a reflective unit to increase phase retardation accumulated of light propagating through the liquid crystal layer and adjust the area of reflective unit so as to provide improved similarity between a voltage-transmittance (V-T) curve and a voltage-reflection (V-R) curve and also to enhance light utilization efficiency.

### BRIEF DESCRIPTION OF THE DRAWINGS

The objectives, features, advantages, and embodiments of the present invention can be more fully understood, with reference made to the accompanying drawings as follows:

FIG. 1 is a cross-sectional view of a first embodiment according to the present invention;

FIG. 2 is a top view of FIG. 1;

FIG. 3 is a top view of a second electrode shown in FIG. 1;

FIG. 4 is a top view of a first electrode shown in FIG. 1;

FIG. 5 is a top view of a reflective layer shown in FIG. 1;

FIG. 6 is a simulated equipotential line distribution diagram of a liquid crystal layer of FIG. 1 in X direction and Z direction;

FIG. 7 is the distribution diagram of LC director of the liquid crystal layer of FIG. 1;

FIG. 8 shows distribution of liquid crystal molecules at a midway position (namely a cross section taken along line 8-8 of FIG. 1) of height of the liquid crystal layer shown in FIG. 1;

FIG. 9 shows curves of simulated transmittance T, reflectance R and light utilization efficiency (R+T) with respect to radius R2 of reflective unit under the conditions that radius R1 of the bare unit 31 of the first electrode is 12 μm;

FIG. 10 shows curves of simulated dRMS with respect to radius R2 of the reflective unit under the conditions that the radius R1 of the bare unit 31 of the first electrode is 12 μm;

FIG. 11 shows a V-T curve and a V-R curve obtained through trading-off between the two indexes of FIG. 9 and FIG. 10 under the optimum conditions of the radius R2 of the reflective unit being 14 μm and the maximum operating voltage Vmax being 6V;

FIG. 12 is a top view showing an embodiment that increases the number of the bare unit of the first electrode of FIG. 1;

FIG. 13 is a cross-sectional view of a second embodiment according to the present invention; and

FIGS. 14a-14e are top views showing examples of usable pattern for the second electrode according to the second embodiment of the present invention.

### DETAILED DESCRIPTION OF THE INVENTION

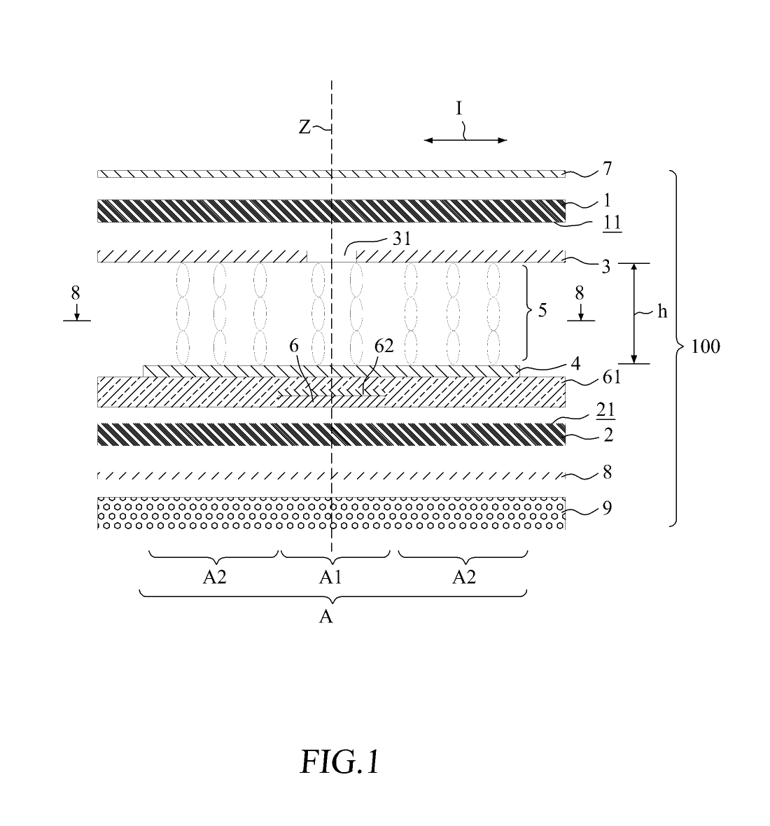

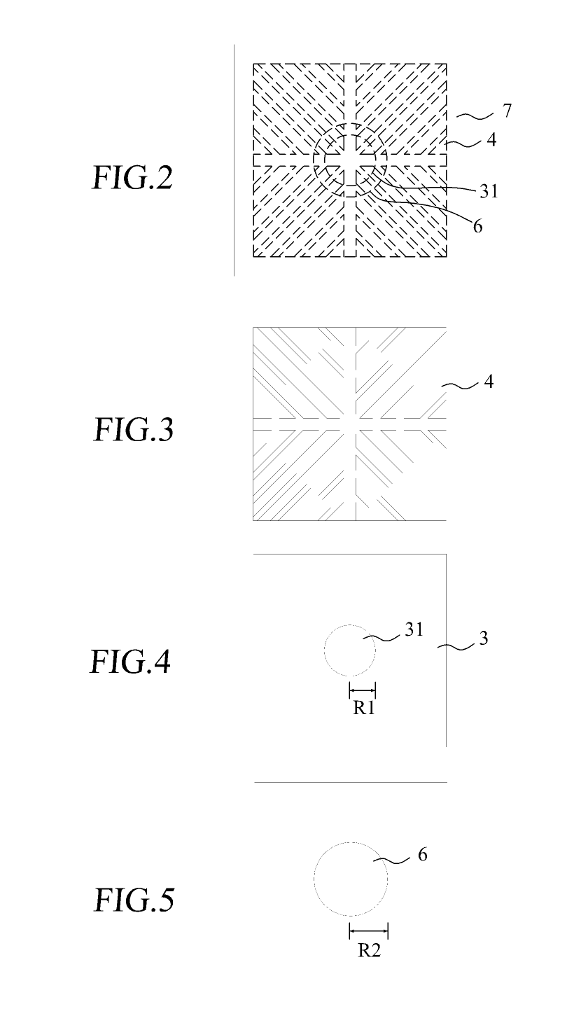

Reference is now made to FIGS. 1 and 2, of which FIG. 1 is a cross-sectional view of a first embodiment according to the present invention and FIG. 2 is a top view of FIG. 1. The instant embodiment will be described by taking Twisted-Vertical Aligned Mode (TVA Mode) as an example (of which each pixel is composed of a single liquid crystal display unit or multiple liquid crystal display units). The liquid crystal display device with transmissive and reflective units according to the present embodiment, generally designated at 100, comprises a first substrate 1 having a bottom surface 11, a second substrate 2 having a top surface 21 opposite to the first substrate 1, a first electrode 3, and a second electrode 4 opposite to the first electrode 3.

A liquid crystal layer 5 is disposed between the first electrode 3 and the second electrode 4. The liquid crystal layer 5 may comprise a negative liquid crystal material (dielectric anisotropy Δ∈<0) doping with chiral agent having an optical path difference being Δn·h=0.53, wherein Δn is the optical birefringence of liquid crystal and h is the thickness of the liquid crystal layer.

At least a bare unit 31 is formed in a geometric center Z of the first electrode 3. The first electrode 3 is an ITO transparent electrode.

The second electrode 4 is an ITO transparent electrode and has a completely un-etched or selectively etched ITO pattern. With reference to FIGS. 2 and 3, the ITO pattern of the second electrode 4 may be any shape-symmetrical slit electrode pattern and the geometric center of the specific ITO pattern corresponds to the bare unit 31 of the first electrode 3. It is noted that the specific ITO pattern shown in FIGS. 2 and 3 is only one of various examples and not limited this example.

A reflective layer 6 is disposed between the second electrode 4 and the second substrate 2. The reflective layer 6 corresponds in position to the bare unit 31 of the first electrode 3. An insulation layer 61 is formed between the reflective layer 6 and the second electrode 4 and between the reflective layer 6 and the second substrate 2 to ensure insulation between the reflective layer 6 and the second electrode 4.

A liquid crystal display unit A is defined in the extension direction I between the first electrode 3 and the second electrode 4. The area of the liquid crystal display unit A that corresponds to the bare unit 31 of the first electrode 3 is defined as a reflective unit A1, while the other area of the liquid crystal display unit A that surrounds outside the reflective unit A1 is defined as a transmissive unit A2. The effective electrical field of the liquid crystal layer in the reflective unit A1 is weaker than the effective electrical field of the liquid crystal layer in the transmissive unit A2.

The first electrode 3 provides a primary function of aligning the liquid crystal molecules in the liquid crystal layer 5 to selectively form a multi-domain configuration or a continuous domain configuration in order to realize a wide viewing angle display. The shape of the bare unit 31 provides an additional function of enhancing dynamic rapid stability of liquid crystal.

The shape of the bare unit 31 can be any one of the symmetry geometries of circle, ellipse, and rectangle. In one embodiment, the shape of the bare 31 is a circle having a radius R1 (see FIG. 4). The function of the reflective layer 6 is to reflect the ambient light, and the reflective layer 6 is set at a location corresponding to the bare unit 31 of the first electrode 3.

The reflective layer 6 is located within the reflective unit A1 corresponding to the bare unit 31 of the first electrode 3 and has a shape of any one of the symmetrical geometries of circle, ellipse, and rectangle. In one embodiment, the shape of the reflective layer 6 is a circle having a radius R2 (see FIG. 5). The electric field of the reflective unit A1 is weaker than the electric field of the transmissive unit A2. The radius R2 of the shape of the reflective layer 6 can be greater than, smaller than, or equal to the radius R1 of the bare unit 31.

A first polarizer 7 is disposed on a top surface of the first substrate 1. A second polarizer 8 is disposed on a bottom surface of the second substrate 2. The first polarizer 7 has an optical absorption axis that is perpendicular to an optical absorption axis of the second polarizer 8. A backlight unit 9 is disposed on a bottom surface of the second polarizer 8.

The reflective layer 6 is made of a non-conductive material, and the reflective layer 6 is disposed between the second electrode 4 and the backlight unit 9 or between the liquid crystal layer 5 and the second electrode 4. Selectively provided on a top surface of the reflective layer 6 is a compensation plate 62, which can be a quarter-wave plate or a combination of a quarter-wave plate and a half-wave plate. Further, a vertical alignment film (not shown) can be disposed on a surface of either one or both of the first electrode 3 and the second electrode 4.

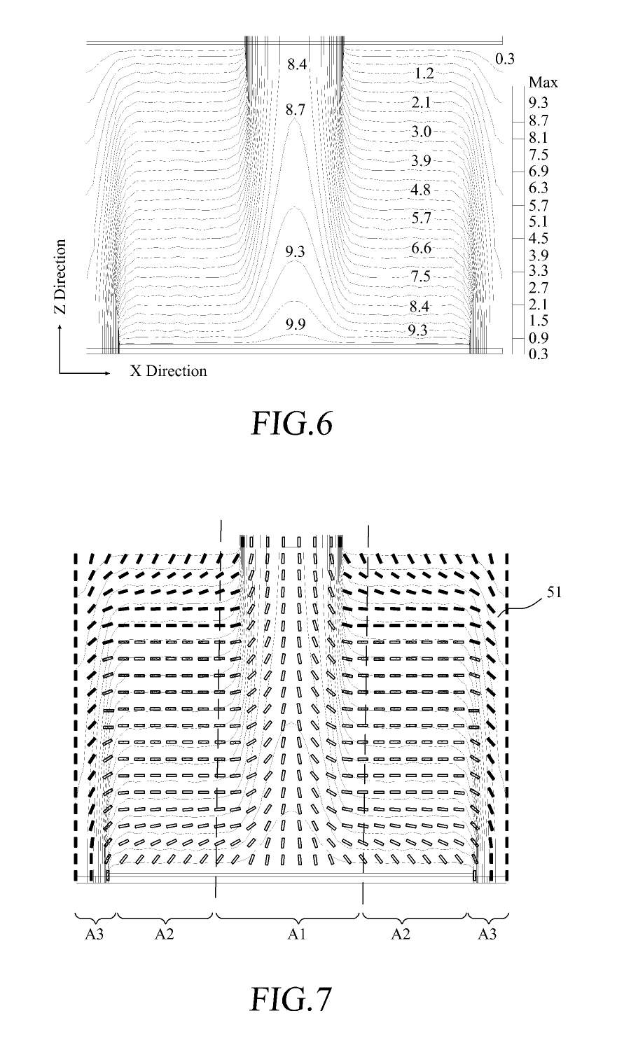

FIG. 6 is a simulated equipotential line distribution diagram of the liquid crystal layer 5 of FIG. 1 in X direction and Z direction. The interval between adjacent equipotential lines is 0.9V in the drawing. The center of the liquid crystal display device 100 is the bare unit 31 of the first electrode 3, and the equipotential line density within the bare unit 31 of the first electrode 3 is lower than the equipotential line density of the other solid area of the first electrode 3. Since an electric field in an area is induced by the gradient of the equipotential lines in the area, it is clear that the electric field of the bare unit 31 is weaker. FIG. 7 is a distribution diagram of LC director of the liquid crystal layer 5 of FIG. 1, and the distribution is obtained as a result of software simulation. In FIG. 7, it is obvious that the tilt degree (angle) of the liquid crystal molecules 51 of the liquid crystal layer 5 in the bare unit 31 of the first electrode 3 is smaller than that of the liquid crystal molecules 51 in the other solid area of the first electrode 3, and thus the phase retardation of the liquid crystal layer 5 in the bare unit 31 is smaller and transmittance is smaller. If the bare unit 31 is used as a reflective unit, since the path along which light propagated is doubled, the phase retardation of the liquid crystal layer 5 is also doubled and higher reflectivity is obtained. Thus, in respect of the overall light utilization efficiency, this structure of partial transmittance and partial reflection mixed mode is better than the structure of complete transmissive mode.

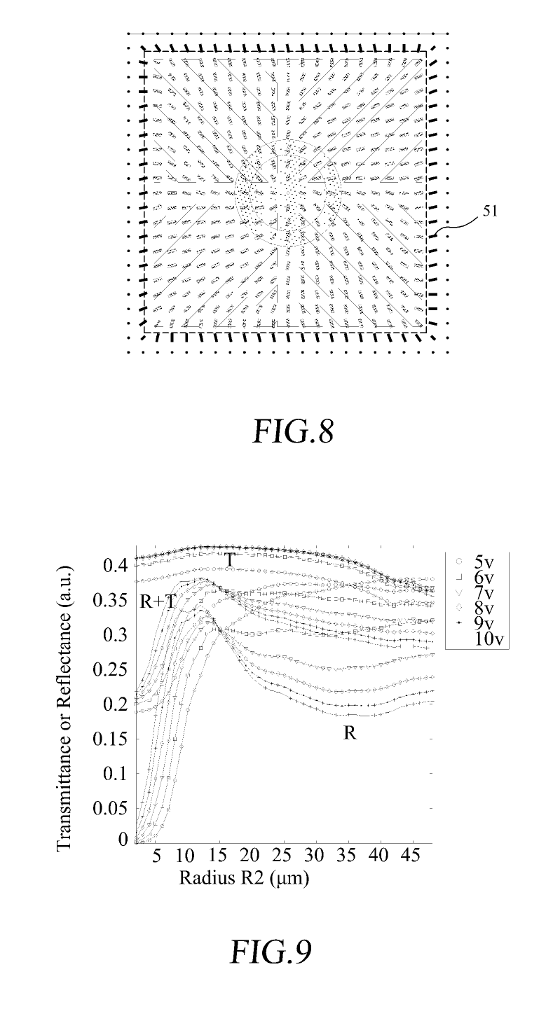

FIG. 8 shows the distribution of liquid crystal molecules at a midway position (namely cross section taken along line 8-8 of FIG. 1) of the height of the liquid crystal layer 5 of FIG. 1. The distribution form of the liquid crystal molecules 51 is effected by the etched pattern of the second electrode 4 and shows a radial form or generally a four-domain form of alignment. Thus, the transmissive and the reflective units both have wide viewing angle characteristics because of the multi-domain alignment characteristic of the liquid crystal molecules.

The position and range of the reflective layer 6 affect the similarity of the V-T curve and the V-R curve and the light utilization efficiency of the whole pixel, and thus traded-off between the two will determine the range of the reflective layer 6. The definition of similarity of the V-T curve and the V-R curve is:

$$dRMS = \sqrt{\frac{{\sum }_{i = 1}^{N} {( {T}_{i} - {R}_{i} )}^{2}}{N}}$$

where N is the number of samples, and the Tᵢ and Rᵢ are the normalized transmittance and the normalized reflectance for a given voltage Vᵢ respectively. The smaller dRMS value is, the better the similarity of the V-T curve and the V-R curve is. The definition of the light utilization efficiency is:

$$TRL = \frac{{\sum }_{x = 0 , y = 0}^{{x}_{max} , {y}_{max}} ( \begin{matrix}transmittance per unit area + \\ reflectance per unit area\end{matrix} )}{total area of the transmittance area and the reflective area}$$

where x and y represent the length and width of the display unit respectively.

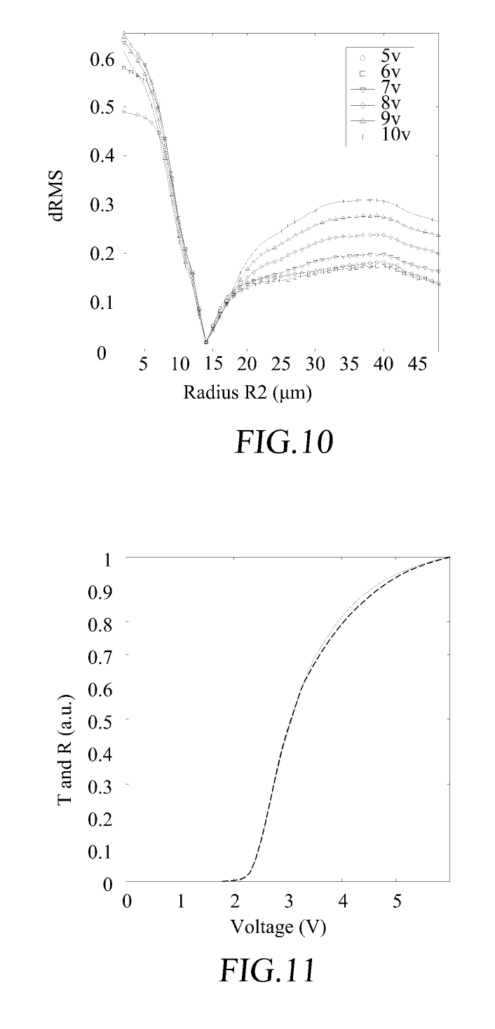

FIGS. 9 and 10 show the simulated transmittance T, reflectance R, light utilization efficiency (R+T) and dRMS with respect to radius R2 of the reflective unit A1 under the conditions that the radius R1 of the bare unit 31 of the first electrode 3 is 12 μm and the reflective unit A1 in located at exactly the center of the structure. The result shows that dRMS is not minimum while the light utilization efficiency is maximum, so that the radius R2 of the reflective unit A1 is determined via trade-off between the two indexes.

The curves shown in FIGS. 9 and 10 indicate simulation results for different maximum operating voltages (5V-10V).

FIG. 11 shows a V-T curve and a V-R curve obtained through trading-off between the aforementioned two indexes under the optimum conditions of the radius R2 being 14 μm and the maximum operating voltage Vmax being 6V. The result shows that the similarity between the V-T curve and the V-R curve is very high, dRMS is 0.013, and the maximum light utilization efficiency TRLmax is 0.362.

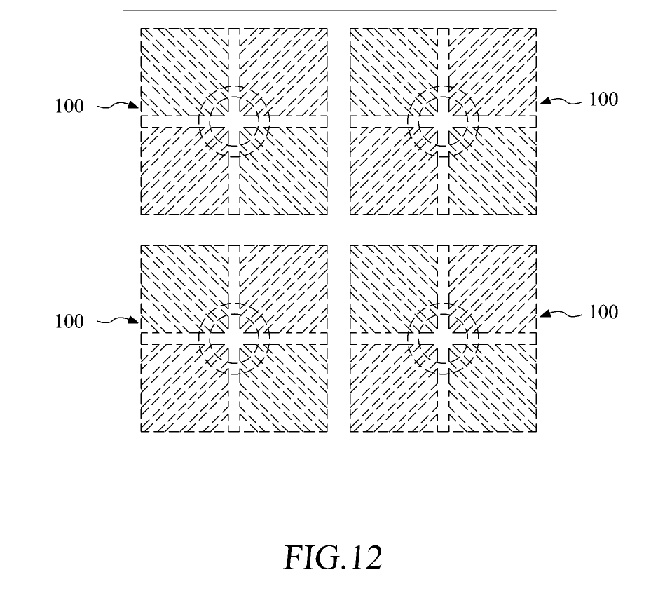

Referring to FIG. 12, in a different embodiment, the number of the bare unit 31 of the first electrode 3 shown in FIG. 1 is changed from a single one to multiple (four such bare units being shown in the drawing but the number being not limited to four and other numbers being also applicable, if desired) in order to make the area ratio between transmissive unit A2 and the reflective unit A1 ranging from 1:1 to 3:1. In the present embodiment, the radius R1 of the bare unit 31 of the first electrode 3 is 10 μm.

Further, referring to FIG. 7, except for the relatively weak electric field in the reflective unit A1, the electric field of the reflective unit at a marginal portion around the liquid crystal display unit (i.e. an outer circumferential edge portion of the transmissive unit A2 spaced away from the reflective unit A1) is also relatively weak. A black matrix may be used to shield such a portion in a regular display device or any of the previously mentioned examples. In the preferred embodiment of the present invention, such a portion is used as a circumferential reflective unit A3 of the liquid crystal display device.

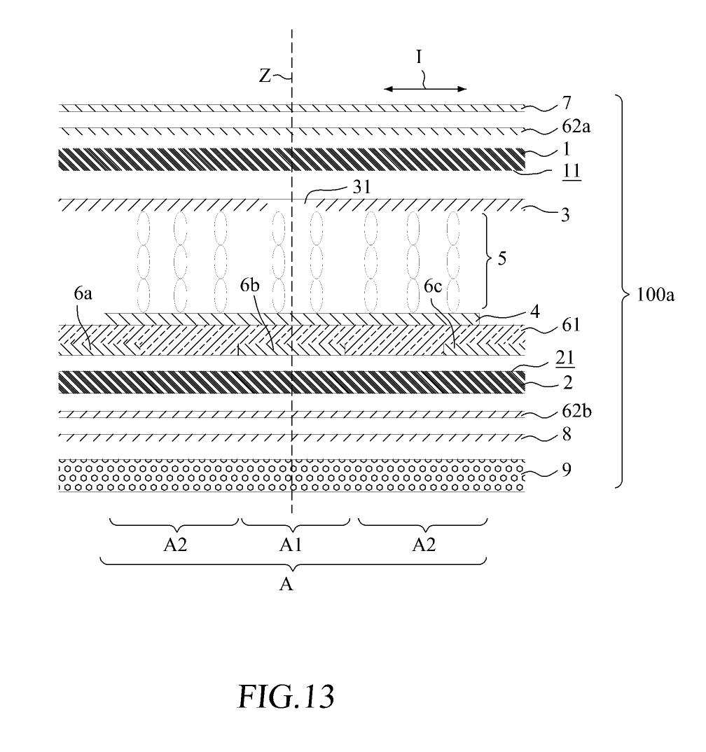

The above-mentioned embodiments are illustrated by taking the TVA mode as an example, but the present invention is also applicable to the vertical aligned mode (VA Mode). Reference is now made to FIG. 13, which is a cross-sectional view of a second embodiment according to the present invention. The liquid crystal display device with transmissive and reflective unit according to the second embodiment of the present invention, generally designated at 100a for easy distinction, is composed of a number of components most of which are identical to the counterparts comprised of the first embodiment shown in FIG. 1, and thus identical components/devices are designated with similar or same references for consistency. A difference of the second embodiment from the embodiment shown in FIG. 1 is that a first compensation plate 62a is disposed between the first substrate 1 and the first polarizer 7 and a second compensation plate 62b is disposed between the second substrate 2 and the second polarizer 8. Further, multiple reflective layer 6a, 6b, 6c that are spaced from each other are arranged between the second electrode 4 and the second substrate 2.

The area and location of the reflective unit A1 is determined via trading-off between the indexes of the light utilization efficiency and the similarity between the Voltage-Transmittance curve and the Voltage-Reflective curve. In the present embodiment, the radius R1 of the bare unit 31 of the first electrode 3 is 10 μm, and the reflective unit A1 is disposed at a center position among four domain areas of the liquid crystal display unit A (the reflective unit being a square having a width of 9 μm), and a circumferential reflective unit of the liquid crystal display unit has a width of is 5 μm.

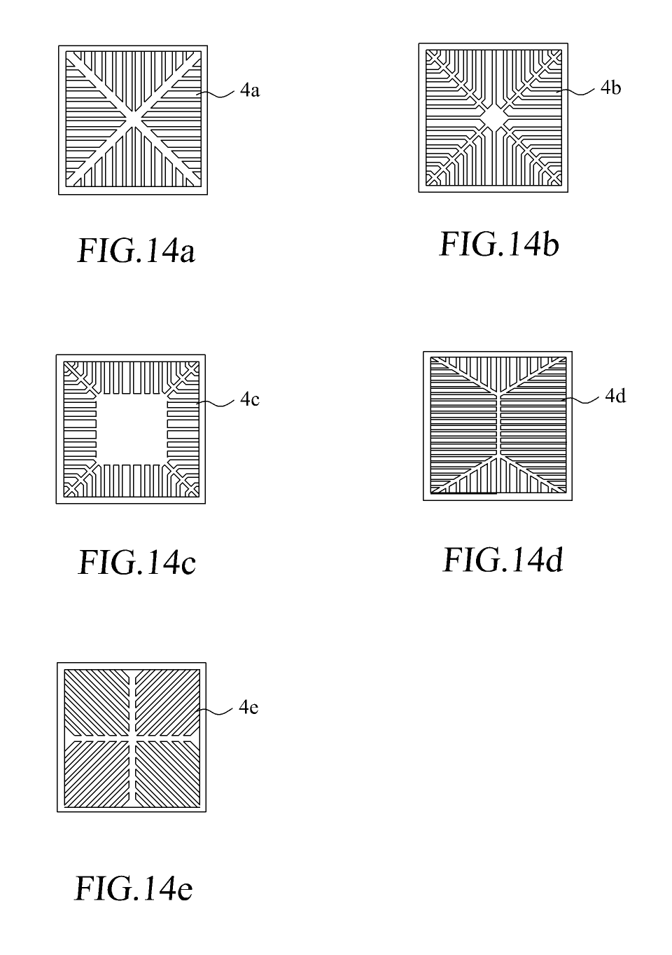

The pattern of the second electrode of the present embodiment is not limited to the foregoing example. The second electrode may have a surface that is completely un-etched or is selectively etched to form a specific pattern. Any pattern that provides symmetrical ITO slit pattern can replace the pattern illustrated in the first embodiment. FIGS. 14a-14e are top views showing examples of usable pattern for the electrode. FIG. 14a shows a pattern of the second electrode 4a that is similar to the pattern of the second electrode 4 (shown in FIG. 3) of the first embodiment, but the pattern shown in FIG. 3 is rotated by 45 degrees. The patterns of the second electrode 4b, 4c shown in FIGS. 14b and 14c are a combination of partial symmetrical ITO slit pattern and partial symmetrical ITO solid pattern, wherein the symmetrical ITO solid pattern is not limited to a square, but can also be one of the symmetry geometries of circle, ellipse, rectangle, and the likes. Further, the locations of the solid unit and the slit unit can be exchanged, for example, the solid pattern being in the outer region and the slit pattern being in the inner region. The patters of the second electrode 4d, 4e shown in FIGS. 14d and 14c are different modifications of the pattern shown in FIG. 14a.

In the present invention, the second electrode can be such that a surface is completely un-etched or is selectively etched to form a specific pattern that is primarily of a herringbone or radial configuration to provide a function of aligning the liquid crystal molecules to form a multi-domain configuration or a continuous domain configuration for realizing a wide viewing angle. For enhancing dynamic rapid stability of liquid crystal, the second electrode is made hollow as a specific shape, such as a circle, a square, or the other symmetrical shapes. The density of the equipotential lines in the hollow shape is lower compared to the density of the equipotential lines in other area, and thus the electric field is weaker and the electric field force applying to the liquid crystal molecules is smaller. Thus, phase retardation of the liquid crystal layer in such area is smaller, and the transmittance in such area is relatively weaker to make a lower pixel transmittance and a lower light utilization efficiency. Such unit is changed to serve as a reflective unit in the present invention, so that the phase retardation of the liquid crystal layer in reflective unit is substantially doubled as compared to the phase retardation the liquid crystal layer in transmissive unit, and thus the reflectance can possibly get higher than the original transmittance ratio. The size and location of the reflective unit is determined via trading-off between the two indexes of the light utilization efficiency and the similarity between the Voltage-Transmittance curve and the Voltage-Reflective curve in order to obtain very closely similar V-T curve and V-R curve, and enhance the light utilization efficiency.

Although the present invention has been described with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A liquid crystal display device with transmissive and reflective units, comprising:
a first polarizer;
a pair of substrates provided opposite to each other which including;
a first substrate;
a first electrode disposed on the first substrate, and at least a bare unit is disposed in the geometric center of the first electrode;
a second substrate opposite to and parallel to the first substrate;
a second electrode disposed on the second substrate and opposite to the first electrode;
a second polarizer;
a liquid crystal layer disposed between the first electrode and the second electrode; and
at least a reflective layer disposed below the second electrode and corresponding to the bare unit of the first electrode;
wherein a liquid crystal display unit having a portion corresponding to the bare unit of the first electrode and forming a reflective unit, the liquid crystal display unit having another portion surrounding the reflective unit and defined as a transmissive unit, the reflective unit showing an effective electrical field of the liquid crystal layer that is weaker than an effective electrical field of the liquid crystal layer in the transmissive unit.

2. The liquid crystal display device with transmissive and reflective units of claim 1, wherein the liquid crystal layer comprises a negative liquid crystal material doped with a chiral dopant.

3. The liquid crystal display device with transmissive and reflective units of claim 1, wherein the bare unit of the first electrode has a symmetrical shape.

4. The liquid crystal display device with transmissive and reflective units of claim 1, wherein the second electrode has a completely un-etched or selectively etched pattern with symmetrical shape.

5. The liquid crystal display device with transmissive and reflective units of claim 1, wherein the reflective layer comprises a metal conductive material, and an insulation layer is disposed between the reflective layer and the second electrode and between the reflective layer and the second substrate to ensure insulation between the reflective layer and the second electrode.

6. The liquid crystal display device with transmissive and reflective units of claim 1, wherein the reflective layer comprises a non-conductive material and the reflective layer is disposed between the second electrode and a backlight unit or between the liquid crystal layer and the second electrode.

7. The liquid crystal display device with transmissive and reflective units of claim 1, wherein the transmissive unit of the liquid crystal display unit has a circumferential edge portion that is spaced away from the reflective unit and serves as a circumferential reflective unit of the liquid crystal display unit.

8. The liquid crystal display device with transmissive and reflective units of claim 1 further comprising a phase compensation plate disposed between the reflective layer and the second electrode.

9. The liquid crystal display device with transmissive and reflective units of claim 1, wherein the liquid crystal layer comprises a negative liquid crystal material.

10. The liquid crystal display device with transmissive and reflective units of claim 1 further comprising a first phase compensation plate disposed between the first polarizer and the first substrate.

11. The liquid crystal display device with transmissive and reflective units of claim 1 further comprising a second phase compensation plate disposed between the second polarizer and the second substrate.
